(19) United States
(12) Patent Application Publication
(10) Pub. No.: US 2014/0264116 A1
(43) Pub. Date: Sep. 18, 2014

(54) EXTENDED RUN FITTING

(71) Applicants: Robert P. Cappadora, Bethpage, NY (US); Nicholas Cappadora, Bethpage, NY (US)

(72) Inventors: Robert P. Cappadora, Bethpage, NY (US); Nicholas Cappadora, Bethpage, NY (US)

(21) Appl. No.: 13/833,020

(22) Filed: Mar. 15, 2013

(51) Int. Cl. F16L 13/10; F16L 13/08

(52) U.S. Cl. CPC F16L 13/103; F16L 13/08
USPC 251/148; 285/133.11; 228/170; 156/256

(57) ABSTRACT

A method of installing a pipe fitting that includes providing a pipe fitting including an extended run portion having a length that is greater than a length of the opposing run portion of the pipe fitting, and removing a portion of a line of pipe to provide an opening. The extended run portion of the pipe fitting is slid over the first end of the line of pipe within the opening formed in the line of pipe. The pipe fitting may then be moved to a second position by sliding the opposing run portion of the pipe fitting over the second end of the line of pipe, while the extended run portion of the pipe fitting is still present over the first end of the line of pipe. The pipe fitting is fused to the first and second end of the line of pipe.

### FIELD OF THE INVENTION

Methods and apparatuses are disclosed herein for forming splices in pipe lines, such as those commonly used as water conduits in residential and commercial buildings.

### BACKGROUND OF THE INVENTION

Pipes, such as copper pipes, are widely used today as water conduits in residential and commercial buildings. The most prevalent manner in which copper pipes are joined to provide a network of water conduits is that known as sweat soldering. To sweat solder the adjacent ends of two copper pipes, the adjacent ends of the copper pipes are brought into contact with one another, and solder is applied to the copper pipes, which are heated, as with an open flame. The solder melts and flows beneath the overlap of the male and female ends of the copper pipes, wherein once the solder cools and solidifies, a water-tight joint results.

### SUMMARY

In one embodiment, a pipe fitting is provided having an extended run portion. Specifically, in one embodiment, the pipe fitting comprises a body including a first run portion (also referred to as extended run portion), a second run portion and a bull portion. The bull portion of the body is present between the first run portion and the second run portion so that a first length for the first run portion is greater than a second length for the second run portion. A passageway is present though the body including a first opening to the first run portion, a second opening to the second run portion and a bull opening to the bull portion of the body.

In another aspect, a pipe fitting is provided that includes an extend run portion and a valve. In one embodiment, the pipe fitting includes a first run portion with a first length and a second run portion with a second length. The second length of the second run portion is at least twice the first length of the first run portion. A valve is present between the first run portion and the second run portion of the pipe fitting.

In another aspect, a method of installing a pipe fitting is provided, in which the pipe fitting includes an extended run portion having a length that is greater than a length of the opposing run portion of the pipe fitting. A portion of a line of pipe is removed to provide an opening having an open length between a first end of the line of pipe and a second end of the line of pipe. The open length that is formed in to the line of pipe is less than a combined length of the extending run portion and the opposing run portion of the fitting. The extended run portion of the pipe fitting is slid over the first end of the line of pipe that is exposed so that the pipe fitting is positioned within the opening formed in the line of pipe. The pipe fitting may then be moved to a second position by sliding the opposing run portion of the pipe fitting over the second end of the line of pipe, while the extended run portion of the pipe fitting is still present over the first end of the line of pipe. The extended run portion of the pipe fitting may be fused to the first end of the line of pipe. The opposing run portion of the pipe fitting may be fused to the second end of the line of pipe.

### DESCRIPTION OF SEVERAL VIEWS OF THE DRAWING

The following detailed description, given by way of example and not intended to limit the present disclosure solely thereto, will best be appreciated in conjunction with the accompanying drawings, wherein like reference numerals denote like elements and parts, in which:

FIG. 1 is a perspective view of one embodiment of a pipe fitting including an extended run portion, in accordance with the present disclosure.

FIG. 2 is a side cross-sectional view of one embodiment of the pipe fitting that is depicted in FIG. 1.

FIG. 3 is a side cross-sectional view of another embodiment of a pipe fitting having an extended run portion and a reducing opposing run portion, in accordance with the present disclosure.

FIG. 4 is a perspective view of another embodiment of a pipe fitting having an extended run portion and including a valve, in accordance with the present disclosure.

FIGS. 5A-5G depict one embodiment of a method of installing a pipe fitting including an extended run portion, in accordance with the present disclosure.

### DETAILED DESCRIPTION

Detailed embodiments of the methods and structures of the present disclosure are described herein; however, it is to be understood that the disclosed embodiments are merely illustrative of the disclosed methods and structures that may be embodied in various forms. In addition, each of the examples given in connection with the various embodiments of the disclosure are intended to be illustrative, and not restrictive. References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure. For purposes of the description hereinafter, the terms “upper”, “lower”, “top”, “bottom”, “left”, “right” and “derivatives thereof” shall relate to the disclosed structures, as they are oriented in the drawing figures.

Typically, the procedure to splice fittings into existing pipe lines requires that a portion of the pipe that is desired to be removed be cut from the line of pipe. The portion of the pipe being removed typically has to have a length that corresponds to the run portions of the pipe fitting being inserted into the opened portion of the pipe line. If the opening in the pipe line is too big, the pipe fitting will not be able to provide a sealing engagement to both ends of the opened pipe line. If the opening is too small, there will not be enough room for the fitting to be inserted between the two exposed ends of the pipe line. To insert the pipe fitting into the opening produced by removing the portion of the line, the exposed pipe ends are typically laterally pushed, pulled or momentarily deformed in a manner that allows for the pipe fitting to be inserted between the exposed pipe ends in the opened portion of the pipe line. The pushing and pulling of the pipes to provide enough clearance for the pipe fitting to be positioned between the pipe ends of the opening is referred to as lateral movement of the pipes. This can be a labor intensive procedure. The methods and structures disclosed herein provide a pipe fitting having an extended run, which allows for installation into an opening of a pipe line without requiring lateral movement of the pipe ends that are exposed by forming the opening in the pipe line.

In one embodiment, the present disclosure provides a pipe fitting, and a method of installing a pipe fitting, in which the pipe fitting includes an extended run portion. The extended run portion reduces the amount of labor for installation of the pipe fitting. More specifically, in some embodiments, the extended run portion of the pipe fitting allows for the pipe fitting to be slid in a first direction onto a first end of a pipe that is exposed by removing a portion of the line. The opposing end of the pipe that is exposed by removing the portion of the line does not have to be moved to provide clearance for the pipe fitting to be positioned between the opposing ends of the line. Once the pipe fitting is positioned within the opening, the fitting may be slid in a second direction, i.e., opposite the first direction, so that the opposing run portion is present over a second end of the pipe that is exposed by removing the portion of the line, while the extended run portion still remains over the first end of the pipe.

Referring to FIG. 1, in one embodiment, the pipe fitting 100 includes a body having a first run portion 10, a second run portion 20 and a bull portion 30. The body is the solid portion of the pipe fitting 100, which may be composed of a metal or a polymeric material. For example, the body may be composed of PVC. Typically, when the body of the pipe fitting 100 is composed of a metal, the metal composition may be composed of copper. In some embodiments, the pipe fitting 100 may be composed of high purity copper, which is generally 99% or more copper. In some examples, the body may be composed of seamless pipe in copper alloy 122, also known as alloy UNS No. C12200 (previous designation is “DHP Copper”) in schedule 40 and 80 wall thicknesses. Alloy 122 is a phosphorus-deoxidized copper, with high residual phosphorus. For example, the copper alloy that provides the body of the pipe fitting may be 99.9% copper (Cu) with a phosphorus content of 0.02% phosphorus or less. In another example, the body is composed of brass. In some embodiments, the body of the pipe fitting 100 may be composed of a plastic, such as PVC or PEX.

The term “run” when describing the first and second run portions 10, 20 of the pipe fitting 100 denotes the portions of the pipe fitting 100 that engage the ends of the pipe line that are exposed by the opening that is formed in the pipe line in order to splice the pipe fitting 100 into the pipe line. The length of the portions, i.e., first run length L1 of the first run 10 and second run length L2 of the second run 20, of the pipe fitting 100 that engages the pipe line are referred to as the “solder cup length” in Table 1. Therefore, the direction extending from the first run 10 to the second run 20 is typically parallel to the direction of travel for the pipe line that is being spliced. The length L1 of the first run portion 10 is greater than the length L2 of the second run portion 10. Therefore, the first run portion 10 of the pipe fitting 100 may also be referred to as an “extended run portion” of the pipe fitting 100. The term “bull” when describing the bull portion 30 of the pipe fitting 100 denotes the portion of the pipe fitting 100 that deviates from the direction of travel of the pipe line into which the pipe fitting 100 is being spliced. The bull portion 30 of the body is present between the first run portion 10 and the second run portion 20 so that a first length L1 for the first run portion 10 is greater than a second length L2 for the second run portion 20. A passageway is present though the body of the pipe fitting 100 including a first opening 11 to the first run portion 10, a second opening 21 to the second run portion 20 and a bull opening 31 to the bull portion 30 of the body. The bull portion 30 of the body may be an inlet or an outlet to the pipe fitting 100.

Referring to FIG. 2, in one embodiment, the first length L1 of the first run portion 10 is at least twice (2×L2) the second length L2 of the second run portion 20. The increased length of the first run portion 20, i.e., extended run portion, provides for sliding engagement of the pipe fitting 100 onto an end of the pipe line that is exposed by creating the opening in the pipe line so that the pipe fitting 100 can be installed without requiring lateral movement of the pipe ends to provide clearance for the pipe fitting 100 to be positioned within the opening. In the embodiment that is depicted in FIGS. 1 and 2, the first opening 11 of the first run portion 10 has a diameter D1 that is equal to the diameter D2 of the second opening 21 of the second run portion 20.

In one embodiment, the second length L2 of the second run portion 20 may range from 0.3 inches to 4.65 inches depending upon the diameter of the pipe line that the pipe fitting 100 is being installed on. In another embodiment, the second length L2 of the second run portion 20 may range from 0.8 inches to 2.5 inches. In one embodiment, the inside diameter D2 of the second opening 21 of the second run portion 20 for a female fitting, i.e., solder cup, may range from 0.25 inches to 12.25 inches. In another embodiment, the inside diameter D2 of the second opening 21 for a female fitting, i.e., solder cup, may range from 0.85 inches to 5.2 inches. Examples for dimensions of the second length L2 of the second run portion 20 and the inside diameter D2 for the second opening 21 may be any value that is within the aforementioned ranges. It is noted that the above ranges are provided for illustrative purposes only, and are not intended to limit the present disclosure.

For example, the second length L2 of the second run portion 20 and the second opening 21 of the second run portion 20 is typically dependent upon the outside diameter of the line of pipe that the pipe fitting 100 is being installed onto. Table 1 includes the dimensional data for the second run portions of the pipe fittings 100 for installation on pipe lines having an outer pipe diameter (Nominal Water Tube Size) ranging in size from ⅛ inches to 12 inches, in accordance with some embodiments of the present disclosure.

TABLE 1

| | | Fittings | Solder Joint | Copper Alloy- | Solder Joint | Copper Alloy- |
|---|---|---|---|---|---|---|
| | | Tolerances | Fittings | Pressure | Fittings | Drainage |
| Normal | Solder Joint- | (Solder Cup) | Fitting End | Solder Cup | Fitting End | Solder Cup |
| Water Tube | Female End | Diameter | Length | Length | Length | Length |
| Size | Min. Inch (mm) | Max Inch (mm) | Min. Inch (mm) | Min. Inch (mm) | Min. Inch (mm) | Min. Inch (mm) |
| ⅛ | 0.252 (6.40) | 0.256 (6.50) | 0.31 (7.9) | 0.25 (6.4) | N/A N/A | N/A N/A |
| ¼ | 0.377 (9.58) | 0.381 (9.68) | 0.38 (9.7) | 0.31 (7.9) | N/A N/A | N/A N/A |
| ⅜ | 0.502 (12.75) | 0.506 (12.85) | 0.44 (11.2) | 0.38 (9.7) | N/A N/A | N/A N/A |
| ½ | 0.627 (15.93) | 0.631 (16.03) | 0.56 (14.2) | 0.50 (12.7) | N/A N/A | N/A N/A |
| ⅝ | 0.752 (19.10) | 0.756 (19.20) | 0.69 (17.5) | 0.62 (15.7) | N/A N/A | N/A N/A |
| ¾ | 0.877 (22.28) | 0.881 (22.38) | 0.81 (20.6) | 0.75 (19.1) | N/A N/A | N/A N/A |
| 1 | 1.128 (28.65) | 1.132 (28.75) | 0.97 (24.6) | 0.91 (23.1) | N/A N/A | N/A N/A |
| 1¼ | 1.378 (35.00) | 1.382 (35.10) | 1.03 (26.2) | 0.97 (24.6) | 0.56 (14.2) | 0.50 (12.7) |
| 1½ | 1.628 (41.35) | 1.633 (41.48) | 1.16 (29.5) | 1.09 (27.7) | 0.62 (15.7) | 0.56 (14.2) |
| 2 | 2.128 (54.05) | 2.133 (54.18) | 1.41 (35.8) | 1.34 (34.0) | 0.69 (17.5) | 0.62 (15.7) |
| 2½ | 2.628 (66.75) | 2.633 (66.88) | 1.53 (38.9) | 1.47 (37.3) | N/A N/A | N/A N/A |
| 3 | 3.128 (79.45) | 3.133 (79.58) | 1.72 (43.7) | 1.66 (42.2) | 0.81 (20.6) | 0.75 (19.1) |
| 3½ | 3.628 (92.15) | 3.633 (92.28) | 1.97 (50.0) | 1.91 (48.5) | N/A N/A | N/A N/A |
| 4 | 4.128 (104.85) | 4.133 (104.98) | 2.22 (56.4) | 2.16 (54.9) | 1.06 (26.9) | 1.00 (25.4) |
| 5 | 5.128 (130.25) | 5.133 (130.38) | 2.72 (69.1) | 2.66 (67.6) | 1.31 (33.3) | 1.25 (31.8) |
| 6 | 6.128 (155.65) | 3.133 (79.58) | 3.22 (81.8) | 3.09 (78.5) | 1.62 (41.1) | 1.50 (38.1) |
| 8 | 8.128 (206.45) | 8.133 (206.58) | 4.09 (103.9) | 3.97 (100.8) | 2.12 (53.8) | 2.00 (50.8) |
| 10 | 10.128 (257.25) | 10.133 (257.38) | 4.12 (104.6) | 4.00 (101.6) | N/A N/A | N/A N/A |
| 12 | 12.128 (308.05) | 12.133 (308.18) | 4.62 (117.3) | 4.50 (114.3) | N/A N/A | N/A N/A |

For example, Table 1 provides the range from a minimum second length L2 (Solder Cup Length Min.) of the second run portion 20 for pipe fittings 100 installed onto pipes having an outer pipe diameter (Nominal Water Tube Size) ranging from ⅛ inch to 12 inches. The minimum second length L2 (Solder Cup Length Min) for the second run portion 20 is provided for both pressure solder joint fittings and drainable solder joint fittings. Table 1 also provides the minimum inside diameter D2 (Female End (Solder Cup) Diameter-Min.) and the maximum inside diameter D2 (Female End (Solder Cup) Diameter-Max.) for pipe fittings 100 installed onto pipes having an outer pipe diameter (Nominal Water Tube Size) ranging from ⅛ inch to 12 inches. The inside diameter D2 of the second run portion 20 may be any value within the range specified in Table 1.

The first length L1 of the first run portion 10 of the pipe fitting 100 is typically two times or greater the second length L2 of the second run portion 20. For example, when the first length L1 is twice the second length L2, and the second length L2 of the second run portion 20 ranges from 0.8 inches to 2.5 inches, the first length L1 of the first run portion 10 may range from 1.6 inches to 9.5 inches depending upon the diameter of the pipe that the pipe fitting 100 is being installed on. In another example, when the first length L1 is twice the second length L2, and the second length L2 of the second run portion 20 ranges from 0.8 inches to 2.5 inches, the first length L1 of the first run portion 10 may range from 1.6 inches to 5.0 inches. The first length L1 of the first run portion 10 may also be a dimension that is equal to twice the minimum second length L2 (Fitting End Length Min.) of the second run portion 20 of the pipe fitting 100 that is listed in Table 1. As indicated above, the minimum second lengths that are described in Table 1 correspond to a specific outside diameter for the line of pipe to which the pipe fitting 100 is being installed. It is noted that the above dimensions are provided for illustrative purposes only, and are not intended to limit the present disclosure to only the above examples. Any dimension is suitable for the first length L1 of the first run portion 10, i.e., extended run portion, of the pipe fitting 100, so long as the dimension selected allows for sliding engagement to the pipe end that the pipe fitting 100 is being installed onto with enough adjustment to provide for clearance to be inserted into the opening in the pipe line without lateral movement of the pipe line. Further, the length of the first run portion 10, i.e., extended run portion, should also provide for enough travel for simultaneous engagement to the opposing pipe ends of the opening as the pipe fitting 100 is spliced into the pipe line. Typically, the first length L1 of the first run portion 10 is equal to the sum of the second length L2 of the second run portion 20 and a minimum fitting end length for the first run portion 10 that is required for sealing engagement using a fusion joining technique, such as soldering and/or welding.

It is noted that the present disclosure is not limited to only the embodiments in which the first length L1 of the first run portion 10 is twice the second length L2 of the second run portion L2. For example, in some embodiments, the first length L1 of the first run portion 10 of the pipe fitting 100 may be within the range of 2.25 times to 4.0 times greater the second length L2 of the second run portion 20. In another example, the first length L1 of the first run portion 10 may be within the range of 2.5 times to 3.75 times the second length L2 of the second run portion 20. In yet another example, the first length L1 of the first run portion 10 may be 3.5 times or greater the second length L2 of the second run portion 20. The multiplier by which the first length L1 of the first run portion 10 of the pipe fitting 100 is greater than the second length L2 of second run portion 20 of the pipe fitting 100 may be any value that is between the endpoints of the ranges described above. For example, the multiplier by which the first length L1 of the first run portion 10 of the pipe fitting 100 is greater than the second length L2 of second run portion 20 of the pipe fitting 100 may be any of 2, 2.25, 2.5, 2.75, 3.00, 3.25, 3.5, 3.75 and 4.0.

In the embodiment that is depicted in FIGS. 1 and 2, the first inner diameter D1 of the first opening 11 of the first run portion 10 of the pipe fitting 100 is equal to the first inner diameter D2 of the second opening D2 of the second run portion 20 of the pipe fitting 100. Therefore, the above description of the dimensions for the second diameter D2 for the second opening 21 of the second run portion 20 of the pipe fitting 100 is suitable for describing the dimensions of the first inner diameter D1 of the first opening 11 of the first run portion 10. In the embodiment that is depicted in FIGS. 1 and 2, the first opening 11 and the second opening 21 provide a female socket for engagement to the pipe ends of the opening that is formed in the pipe line. Other embodiments have been contemplated in which at least one of the first opening 11 and the second opening 21 provides a male fitting for engagement into a female socket.

Referring to FIG. 2, the bull portion 30 of the body is present between the first run portion 10 and the second run portion 20. The bull portion 30 may provide an inlet or outlet to the pipe fitting 100. Typically, the direction of flow F1 through the bull portion 30 of the pipe fitting 100 is substantially perpendicular, i.e., at an angle α1 of approximately 90°, to the direction of flow F2 between the first run portion 10 and the second run portion 20. In some embodiments, the direction of flow F1 through the bull portion 30 may be angled with respect to the direction of flow F2 between the first run portion 10 and the second run portion 20. For example, the direction of flow F1 through the pull portion 30 may be angled α1 with respect to the direction of flow F2 between the first run portion 10 and the second run portion 20 by a value ranging from 30° to 150°. In another example, the direction of flow F1 through the bull portion may be angled α1 with respect to the direction of flow F2 between the first run portion 10 and the second run portion 20 by a value ranging from 45° to 135°. The length L3 of the bull portion 30 is typically substantially equal to the diameter D3 of the bull opening 31 to the bull portion 30.

In one embodiment, the diameter D3 of the bull opening 31 is equal to at least one of the first diameter D1 of the first opening 11 to the first run portion 10 and the second diameter D2 of the second opening 21 to the second run portion 20. Therefore, the above description for the diameter D1, D2 to the first and second openings 11, 21 is suitable for the description of the diameter D3 of the bull opening 31 of the bull portion 30. In other embodiments, the bull opening 31 of the bull portion 30 may be a reducing opening or an enlarging opening relative to the first and second opening 11, 21 of the first and second run portions 10, 20 of the pipe fitting 100. For example, the first and second openings 11, 12 of the first and second run portions 10, 20 may be sized to be installed to a first pipe line size, such as a pipe having an outside diameter (nominal water tube size) of 1″, while the bull openings 31 of the bull portion 30 of the pipe fitting 100 may be sized to be installed to a second pipe line size, such as a pipe having an outside diameter (nominal water tube size) of ½″. Other sizes for the diameter D3 of the bull opening 31 of the bull portion 30 of the pipe fitting 100 are provided in Table 1.

In addition to the bull opening 31 providing the female socket for engagement by fusion connections, such as adhesive, clamping, soldering or welding, embodiments have been contemplated in which the bull opening 31 provides a male fitting for engagement into a pipe line having a female socket. Embodiments have also been contemplated in which the bull opening 31 provides for engagement to a pipe line by threaded connection.

FIG. 3 depicts another embodiment of the present disclosure, in which the second run portion 20a has a different diameter for the second opening 21a than the first opening 11a for the first run portion 10a, i.e., extended run portion, of the pipe fitting 100a. This may be referred to as a reducing fitting. It is noted that any dimension is suitable for the first diameter D2a of the first opening 11a of the first run portion 10a, and the second diameter D1a for the second openings 21a of the second run portion 21a. For example, the first opening 11a of the first run portion 10a may be sized to be installed to a first pipe line size, such as a pipe having an outside diameter (nominal water tube size) of 1″, while the second opening 21a of the second run portion 20a of the pipe fitting 100a may be sized to be installed to a second pipe line size, such as a pipe having an outside diameter (nominal water tube size) of ½″. Other sizes for the first diameter D1a of the first opening 11a of the first run portion 10a and the second diameter D2a of the second opening 21a of the pipe fitting 100a are provided in Table 1. It is further noted that although FIG. 3 depicts a reduction in pipe size from the first run portion 10a to the second run portion 20a, it is also within the scope of the disclosure that there is an enlargement in pipe size from the second run portion 20a to the first run portion 10a.

Similar to the embodiment depicted in FIGS. 1 and 2, the pipe fitting 100a depicted in FIG. 3 has an extended run portion, i.e., first run portion, that provides for installing the pipe fitting 100a within an opening that is formed in a pipe line without requiring that the ends of the pipe line be moved laterally to install the pipe fitting 100a. Typically, the first length L1a of the first run portion 10a is equal to the sum of the second length L2a of the second run portion 20a and a minimum fitting end length L4 for the first run portion 10a that is required for sealing engagement using a fusion joining technique, such as soldering and/or welding. The minimum fitting end length L4 is typically dependent upon the size, i.e., outside diameter, of the pipe that the first end portion 20a of the pipe fitting 100a is being installed onto. The minimum fitting end length L4 for engagement to a number of sizes for the outside diameter of a pipe (also referred top as nominal tube size) are provided in Table 1. The second length L2a for the second run portion 20a may also be the minimum fitting end length or greater for the pipe size, i.e., outside diameter, of the pipe end that the second run portion 20a is installed to. The minimum fitting end length for engagement to a number of sizes for the outside diameter of a pipe (also referred top as nominal tube size) are provided in Table 1.

Referring to FIG. 3, the bull portion 30a of the body is present between the first run portion 10a and the second run portion 20a. The bull opening 31a of the bull portion 30a may have a diameter that is the same as the diameter to one of the first opening 11a of the first run portion 10a or the second opening 21a of the second run portion 20a. The bull portion 30a of the pipe fitting 100a that is depicted in FIG. 3 is similar to the bull portion 30 of the pipe fitting 100 that is depicted in FIGS. 1 and 2. Therefore, the description of the bull portion 30 of the pipe fitting 100 that is depicted in FIGS. 1 and 2 is suitable for the description of the bull portion 30a of the pipe fitting 100a that is depicted in FIG. 3.

FIG. 4 depicts another embodiment of a pipe fitting 100b having an extended run portion (first run portion 10b), wherein the pipe fitting 100b further includes a valve portion 30b. Similar to the embodiments that are described above with reference to FIGS. 1-3, the extended run portion (first run portion 10b) provides for installing the pipe fitting 100b including the valve portion 30b within an opening that is formed in a pipe line without requiring that the ends of the pipe line be moved laterally to install the pipe fitting 100b. The valve portion 30b of the pipe fitting 100b may be any valve that is used in plumbing systems, such as ball valves, stop valves, gate valves, check valves, pressure balanced valves, globe valves and combinations thereof.

FIG. 4 depicts a pipe fitting 100b that includes a first run portion 10b, i.e., extended run portion, with a first length L1b on a first side of the valve portion 30b and a second run portion 20b with a second length L2b on a second side of the valve portion 30b, wherein the first length L1b is greater than the second length L2b. In the embodiment that is depicted in FIG. 4, the diameter of the first opening 11b to the first run portion 10b is substantially the same as the diameter of the second opening 21b to the second run portion 20b. Similar to the embodiment depicted in FIGS. 1 and 2, the first length L1b of the first run portion 10b may be two times or greater then second length L2b of the second run portion 20b. Because the first run portion 10b and the second run portion 20b of the pipe fitting 100b that is depicted in FIG. 4 are similar to the first run portion 10 and the second run portion 20 of the pipe fitting 100 that is depicted in FIGS. 1 and 2, the above description of the first and second run portion 10, 20 depicted in FIGS. 1 and 2 is suitable for the first and second run portions 10b, 20b that are depicted in FIG. 4. In another embodiment, a pipe fitting (not shown) is provided including a valve portion that may be present between a first run portion, i.e., extended run portion, and a second run portion, in which the diameter of the first run portion is different than the diameter of the second run portion. This embodiment is similar to the pipe fitting 100 that is depicted in FIG. 3.

In another aspect of the present disclosure, a method of installing a pipe fitting is provided, in which the pipe fitting 200 includes an extended run portion 210, as depicted in FIGS. 5A-5G. The pipe fitting 200 that is depicted in FIGS. 5A-5G is similar of the pipe fitting 100 that is depicted in FIGS. 1 and 2. Therefore, the description of the pipe fitting 100 that is depicted in FIGS. 1 and 2 is suitable for the pipe fitting 200 that is depicted in FIGS. 5A-5G. For example, in one embodiment, the dimensions, e.g., length L1 and inside diameter, for the first run portion 10, i.e., extended run portion, of the pipe fitting 100 that is depicted in FIGS. 1 and 2 is suitable for the dimensions of the extended run portion 210 of the pipe fitting 200 that is depicted in FIGS. 5A-5G. The run portion of the pipe fitting 200 that is on the opposite side of the pipe fitting 200 than the extended run portion 210 may be referred to as the “opposing run portion” of the pipe fitting 200. The opposing run portion 220 of the pipe fitting 200 that is depicted in FIGS. 5A-5G is similar to the second run portion 20 of the pipe fitting 100 that is depicted in FIGS. 1 and 2. Therefore, the above description, such as the length L2 and inside diameter dimensions, of the second run portion 20 of the pipe fitting 100 is suitable for the description of the opposing run portion 220 of the pipe fitting 200 that is depicted in FIGS. 5A-5G. Similar to the embodiments of the pipe fitting that are described in FIGS. 1 and 2, the extended run portion 210 of the pipe fitting 200 depicted in FIGS. 5A-5G has a length L1c that is twice the length L2c or greater of the opposing run portion 220. Further, examples for the diameter of the openings to the extended run portion 210 and the opposing run portion 220 are included in Table 1. The pipe fitting 200 that is depicted in FIGS. 5A-5G is a T-shaped fitting having an bull portion 230 that is present between the first run portion 210, i.e., extended run portion, and the second run portion 220. The above description of the bull portion 30 of the pipe fitting 100 that is depicted in FIGS. 1 and 2 is suitable for the description of the bull portion 230 of the pipe fitting 200 that is depicted in FIGS. 5A-5G.

Although the pipe fitting 200 that is depicted in FIGS. 5A-5G is a T-shaped fitting similar to the pipe fitting 100 that is depicted in FIGS. 1 and 2, the method is not limited to only this type of pipe fitting. Any pipe fitting is suitable for the pipe fitting 200 that is depicted in FIGS. 5A-5G, so long as the pipe fitting has an extended run portion 211. For example, the pipe fittings 100a, 100b that are depicted in FIGS. 3 and 4 are equally applicable for the pipe fitting 200 that is depicted in FIGS. 5A-5G.

Referring to FIGS. 5A and 5B, in one embodiment, the method may begin with removing a portion of a pipe line 300 to provide an opening 305 having an open length L5 between a first end 300a of the line of pipe 300, and a second end 300b of the line of pipe 300. The line of pipe is typically composed of a metal, such as copper, and may be referred to as copper pipe or copper tube. The terms “copper pipe” or “copper tube” generally refer to high copper content (generally 99% or more) pipe or tube. In some examples, the body may be composed of seamless pipe in copper alloy 122, also known as alloy UNS No. C12200 (previous designation is “DHP Copper”) in Schedule 40 and 80 wall thicknesses. For example, the copper alloy that the line of pipe 300 may be composed of may be 99.9% copper (Cu) with a phosphorus content of 0.02% phosphorus or less. In some examples, the line of pipe 300 may be seamless pipe in copper alloy 122, also known as alloy UNS No. C12200 (previous designation is “DHP Copper”) in Schedule 40 and 80 wall thicknesses. The line of pipe may also be composed of other metals, such as brass, or polymeric materials, such as PVC or PEX.

The line of pipe 300 may be sized to have any diameter typically used in plumbing, such as commercial and home plumbing, such as ⅛″, ¼″, ⅜″, ½″, ⅝″, ¾″, ⅞″, 1″, 1¼″, 1½″, 2″, 2½″, 3″, 3½″, 4″, 5″, 6″, 8″, 10″ and 12″. It is noted that the above examples, are provided for illustrative purposes only, and are not intended to limit the present disclosure, as other pipe sizes are equally applicable for use with the present disclosure.

The opening 305 for splicing in the pipe fitting 200 may be formed in the line of pipe 300 using a pipe cutter. The open length L5 that is formed in the pipe line 300 is less than a combined length of the extending run portion 210 and the opposing run portion 220 of the pipe fitting 200 that is being spliced into the pipe line 200. The minimum length L5 for the opening is equal to the combined length of the second length L2 for the second run portion 20 and the length L3 of the bull portion 30 (as depicted in FIG. 2) so that when slid back the lengths for the second length L2 for the second run portion and the first length L1 for the first run portion 10 (as depicted in FIG. 2) cover the pipe at the minimal solder cup length relative to its diameter. See Table 1. The opening length L5 is selected to allow for the pipe fitting 200 to be installed on one end, e.g., first end 300a, of the line of pipe that is exposed by forming the opening 305, and to allow for the pipe fitting 200 to be slid, i.e., laterally moved in a first direction, so that the first end 300a is positioned within the extended run portion 210 of the pipe fitting 200 to a depth that allows for the pipe fitting 200 to be positioned within the opening 305 without substantial lateral movement of the lines of pipe, e.g., without lateral movement of the first end 300a and second end 300b. The opening length L5 is also selected so that once the pipe fitting 200 is positioned within the opening 305, the pipe fitting 200 may be slid, i.e., laterally moved in a second direction that is opposite the first direction, so that the opposing run portion 220 of the pipe fitting 200 can engage a second end 300b of the pipe line, while the extended run portion 210 of the pipe fitting is still engaged to the first end 200a of the pipe line. Although the length L5 of the opening 305 can be dependent upon the requirements for the length L1c of the extended run portion 210 of the pipe fitting 200, and the length L2c of the opposing run portion 220, which can be dependent upon the size of the pipe line 300, the length L5 of the opening 305 can range from 0.5 inches to 12 inches.

Referring to FIG. 5C, in some embodiments, in order to provide sufficient clearance for the pipe fitting 200 to be installed on one end, e.g., the first end 300a, of the line of pipe that is exposed by forming the opening 305, the line of pipe corresponding to the end that the pipe fitting 200 is being installed only may be moved vertically V1, e.g., up or down relative to the person doing the installation facing the line of pipe at eye level. The movement of the first end 300a of the line of pipe may be referred to as angling the first end 300a of the line of pipe away from a direction of travel for the original line of pipe. More specifically, the direction of travel for the original line of pipe is the direction of media flow, e.g., water flow, through the original line of pipe prior to forming the opening 305, as identified by arrow DT1 in FIG. 5C. The vertical movement V1 of the first end 300a of the line of pipe changes the direction of travel for that portion of the line of pipe, as identified by array DT2, wherein the intersection of the two directions provides the angle α2 between the two directions that results from the vertical movement V1 of the first end 300a. Any lateral movement of the pipe at this stage is limited to the angling of the one end of the pipe, e.g., first end 300a, for installing the pipe fitting 200, which is at a minimum, and can be a function of the vertical movement V1. The vertical movement V1 of the end of line of pipe may be minimized, and is some instances can be removed entirely from the sequence of installing the pipe fitting 200.

FIGS. 5D and 5E depict one embodiment of sliding the extended run portion 210 of the pipe fitting 200 over the first end 300a of the line of pipe that is exposed by forming the opening 305. In some embodiment, the pipe fitting 200 can be slid, i.e., moved laterally, to a first position so that the first end 300a of the line of pipe is at a substantially greatest depth within the extended run portion 210 of the pipe fitting 200. During this stage of the installation, the pipe fitting 200 may be moved laterally, e.g., right to left relative to the person doing the installation facing the line of pipe at eye level, while the line of pipe, i.e., first and second end 300a, 300b is not moved laterally. The lateral movement of the pipe fitting 200 at this stage of installation may be referred to as laterally moved or slid in a first direction LD1. At this stage of the installation, there is enough clearance between the opposing run portion 220 of the pipe fitting 200 and the second end 300b of the line of pipe so that the pipe fitting 200 may be positioned within the opening 305.

FIGS. 5F and 5G depict one embodiment of sliding the pipe fitting 200 to a second position so that the opposing run portion 220 is present over the second end 300b of the line of pipe, while the extended run portion 210 of the pipe fitting 200 is present over the first end 300a of the line of pipe. FIG. 5F depicts returning the first end 300a of the line of pipe back to its original position before being angled away from the direction of travel for the line. During this stage of the method, the pipe fitting 200 is now within the opening 305 that has been formed in the line of pipe. FIG. 5G depicts sliding the pipe fitting 200 to the second position. During this stage of the installation, the pipe fitting 200 may be moved laterally, e.g., right to left relative to the person doing the installation facing the line of pipe at eye level, while the line of pipe, i.e., first and second end 300a, 300b, is not moved laterally. The lateral movement of the pipe fitting 200 at this stage of installation may be referred to as laterally moved or slid in a second direction LD2. The sliding of the pipe fitting 200 to the second position provides a continuous passageway from the first end 300a of the line of the pipe to the second end 300b of the line of the pipe, wherein bull portion 230 of the pipe fitting 200 can provide an outlet or inlet as a T-shaped fitting, as depicted in FIG. 5G. In some embodiments, the pipe fitting may install a valve within the continuous passageway from the first end 300a of the line of pipe to the second end 300b of the line of pipe when the pipe fitting includes a valve as illustrated in FIG. 4.

FIG. 5G further depicts fusing the extended run portion 210 of the pipe fitting 200 to the first end 300a of the line of pipe, and fusing the opposing run portion 220 of the pipe fitting 200 to the second end 300b of the line of pipe. The fusing of the extended run portion 210 of the pipe fitting 200 to the first end 300a of the line of pipe, and the fusing of the opposing run portion 220 of the pipe fitting 200 to the second end 300b of the line of pipe may include soldering, welding, clamping or adhesive joining.

While the present disclosure has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A pipe fitting comprising:
a body including a first run portion, a second run portion and a bull portion, wherein the bull portion of the body is present between the first run portion and the second run portion so that a first length for the first run portion is greater than a second length for the second run portion; and
a passageway present though the body including a first opening to the first run portion, a second opening to the second run portion and a bull opening to the bull portion of the body.

2. The pipe fitting of claim 1, wherein the first length of the first run portion is at least twice a length of the second length of the second run portion.

3. The pipe fitting of claim 1, wherein the first length of the first run portion is substantially equal to twice a length of the second length of the second run portion

4. The pipe fitting of claim 1, wherein a first diameter of the first opening to the first run portion is the same as a second diameter of the second opening to the second run portion.

5. The pipe fitting of claim 1, wherein the bull opening to the bull portion of the body has a same diameter as the first diameter to the first opening of the first run portion and the second diameter to the second opening of the second run portion.

6. The pipe fitting of claim 1, wherein the first opening to the first run portion is a female socket, the second opening to the second run portion is a female socket, and the bull opening to the bull portion is a female socket.

7. The pipe fitting of claim 1, wherein a first diameter of the first opening to the first run portion is different than a second diameter of the second opening to the second run portion.

8. The pipe fitting of claim 1, wherein a length of a portion of the passageway that is present through the bull portion of the body is substantially perpendicular to a length of a portion of the passageway extending from the first opening to the first run portion to the second opening of the second run portion.

9. The pipe fitting of claim 1, wherein the bull portion is an outlet or an inlet to the pipe fitting.

10. A pipe fitting comprising:
a first run portion with a first length;
a second run portion with a second length, wherein the second length is at least twice the first length; and
a valve is present between the first run portion and the second run portion.

11. A method of installing a pipe fitting comprising:
providing a pipe fitting including an extended run portion having a length that greater than a length of the opposing run portion of the pipe fitting;
removing a portion of a line of pipe to provide an opening having an open length between a first end of the line of pipe and a second end of the line of pipe, wherein the open length is less than a combined length of the extending run portion and the opposing run portion of the fitting;
sliding the extended run portion of the pipe fitting over the first end of the line of pipe that is exposed by removing the length to a first position so that the pipe fitting is positioned within the opening formed in the line of pipe;
sliding the pipe fitting to a second position so that the opposing run portion is present over the second end of the line of pipe while the extended run portion of the pipe fitting is present over the first end of the line of pipe; and
fusing the extended run portion of the pipe fitting to the first end of the line of pipe and the opposing run portion of the pipe fitting to the second end of the line of pipe.

12. The method of claim 11, wherein the pipe fitting comprises:
a body including the extended run portion, the opposing run portion and a bull portion, wherein the bull portion of the body is present between the extended run portion and the opposing run portion; and
a passageway present though the body including a first opening to the extended run portion, a second opening to the opposing run portion and an bull opening to the bull portion of the body.

13. The method of claim 12, wherein the first length for the extended run portion is at least twice the second length for the opposing run portion.

14. The method of claim 12, wherein the first length for the extended run portion is substantially twice the second length for the opposing run portion.

15. The method of claim 11, wherein the pipe fitting comprises:
the extended run portion with a first length;
the opposing run portion with a second length, wherein the second length is at least twice the first length; and
a valve present between the extended run portion and the opposing run portion.

16. The method of claim 11, wherein the sliding of the extended run portion of the pipe fitting over the first end of the line of pipe comprises:
angling the first end of the line of pipe away from a direction of travel for the line of pipe;
said sliding the extended run portion of the pipe fitting over the first end of the line of pipe; and
returning the first end of the line back to its original position before being angled away from the direction of travel for the line.

17. The method of claim 11, wherein the sliding of the pipe fitting to the second position provides a continuous passageway from the first end of the line of the pipe to the second end of the line of the pipe.

18. The method of claim 11, wherein the fusing of the extended run portion of the pipe fitting to the first end of the line of pipe and the opposing run portion of the pipe fitting to the second end of the line of pipe comprises soldering, welding adhesive joining or clamping.

19. The method of claim 12, wherein the bull portion is an outlet of the pipe fitting.

20. The method of claim 13, wherein the bull portion is the inlet to the pipe fitting.
